(19) United States
(12) Patent Application Publication
(10) Pub. No.: US 2004/0241632 A1
(43) Pub. Date: Dec. 2, 2004

(54) Karaoke service method and system by mobile device

(76) Inventors: Kaoru Tsukamoto, Tokyo (JP); Tomohiro Iwanaga, Tokyo (JP); Toshiharu Okada, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/730,095

(22) Filed: Dec. 9, 2003

(30) Foreign Application Priority Data
May 26, 2003 (JP) 147124/2003

(51) Int. Cl. G09B 5/00

(52) U.S. Cl. 434/307 A

(57) ABSTRACT

This invention provides karaoke system that reduces declination between playing melody signaling an incoming call and displaying characters or pictures. To this end, the karaoke system of this invention plays karaoke song comprising contents with karaoke event data, and synchronization of karaoke events are achieved by executing the events described in time order in the contents of the karaoke by following a timing dictated by synchronization data.

### BACKGROUND OF THE INVENTION

1. Field of the Invention

The present invention relates a system for realizing karaoke in a mobile device such as cellular phone or a Personal Digital Assistant (PDA).

2. Related Art

In recent years it becomes generic to play a melody signaling an incoming call on a cellular phone instead of ring tone. Also by virtue of high functionality of a cellular phone, graphics or pictures can be displayed on the screen in standby status. By this it becomes possible to display characters and pictures together with music, and it becomes possible to play music or play karaoke together with displaying picture or characters on the display of the cellular phone.

Although we can play music by the use of high-performance processor or sound generator, it is difficult to get synchronization between applications such as displaying characters or images or playing music and operating sound generator in limited volume and hardware resources.

To overcome above-mentioned problem it is proposed to synchronize between playing of a melody signaling incoming call and displaying images or characters. But if a playing of a melody signaling incoming call and displaying characters or images begins simultaneously, timing declination between melody and characters (or images) will become obvious at the near end of the music. The declination is augmented especially when communication interruption occurs while playing music.

### SUMMARY OF THE INVENTION

It is an object of this invention to provide karaoke system that reduces declination between playing melody signaling an incoming call and displaying characters or pictures.

To solve the above problem of the prior arts, the karaoke system of this invention plays karaoke song comprising contents with karaoke event data, and synchronization of karaoke events are achieved by executing the events described in time order in the contents of the karaoke data by following a timing dictated by synchronization data.

### BRIEF DESCRIPTION OF THE DRAWINGS

The above and other objects and advantages of this invention will become obvious from the following description with reference of the drawings, wherein:

FIG. 1 is a diagram showing an embodiment of this invention;

FIG. 2 is a diagram showing an exemplary structure of karaoke contents data;

FIG. 3 is a diagram showing an overall flow of operation of this system;

FIG. 4 is a diagram showing data flow between devices of this system;

FIG. 5 is a diagram showing a data structure of karaoke song data;

FIG. 6 is a diagram showing an exemplary structure of Picture Data;

FIG. 7 is a diagram showing a content of Picture Index information;

FIG. 8 is a diagram showing a content of Event Identifier;

FIG. 9 is a diagram showing an exemplary data of Event Data; and

FIG. 10 is a diagram showing an example of synchronization data interposed in song data.

### DETAILED DESCRIPTION OF THE PREFERRED EMBODIMENT

A preferred embodiment of this invention is described in detail with reference to the accompanying drawings.

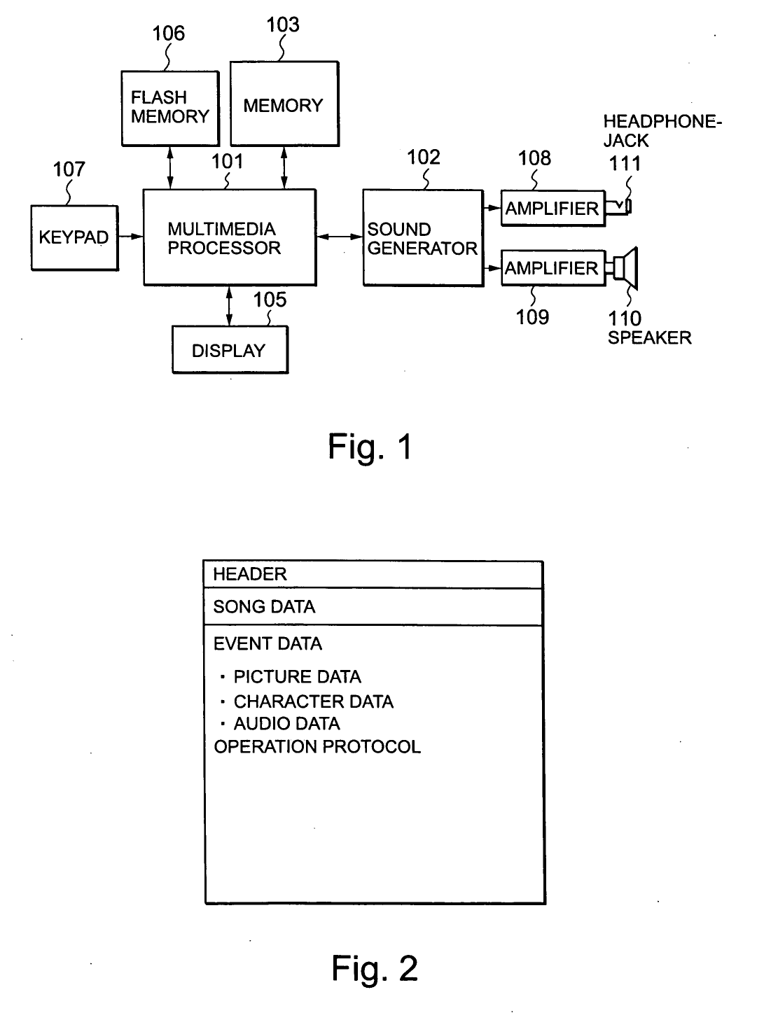

FIG. 1 is a diagram showing an embodiment of this invention. This system comprises multimedia processor 101, memory 103, display 105, keypad 107, flash memory 106 for booting the system, sound generator 102, amplifier 108,109, speaker 110, and headphone-jack 111. Karaoke contents including song data, picture data and text data are stored in the memory 103.

The multimedia processor 101 executes application programs, analyzes contents stored in the memory 103, displays pictures and characters on the display 105, execute the processes designated by interruption data from the key pad 107, sends data to sound generator 102, and receives interrupt from sound generator 102.

The flash memory 106 stores a program for automatic loading an operating system (OS) data and application data from the memory 103 after the system is powered-on.

The sound generator 102 receives data from the multimedia processor 101 and sends audio data to the amplifier 108 or 109 for driving the speaker 110 or headphone-jack 111.

The karaoke contents are stored in the memory 103. FIG. 2 is a diagram showing an exemplary structure of karaoke contents data. The karaoke contents include Header section and Song Data section followed by Character Data, Picture Data and Audio Data necessary for karaoke playing, and also include actuating procedure data (this data is called Event Data). The OS programs downloaded at system power-on time and application programs for playing karaoke are also stored in memory 103.

The Event Data included in karaoke content is arranged in play back order. The timing data for executing each event is embedded in sound as MIDI message in case of Standard MIDI File (SMF). For example, exclusive message (this is a message for handling parameters specific for manufacturer and device) or note on message of note number (this number represents musical scale) of unused instruments such as percussion is also embedded as synchronization start message.

The sound generator does not play music, when receiving synchronization messages, and responds interrupt signal indicating an occurrence of an event to the multimedia processor 101.

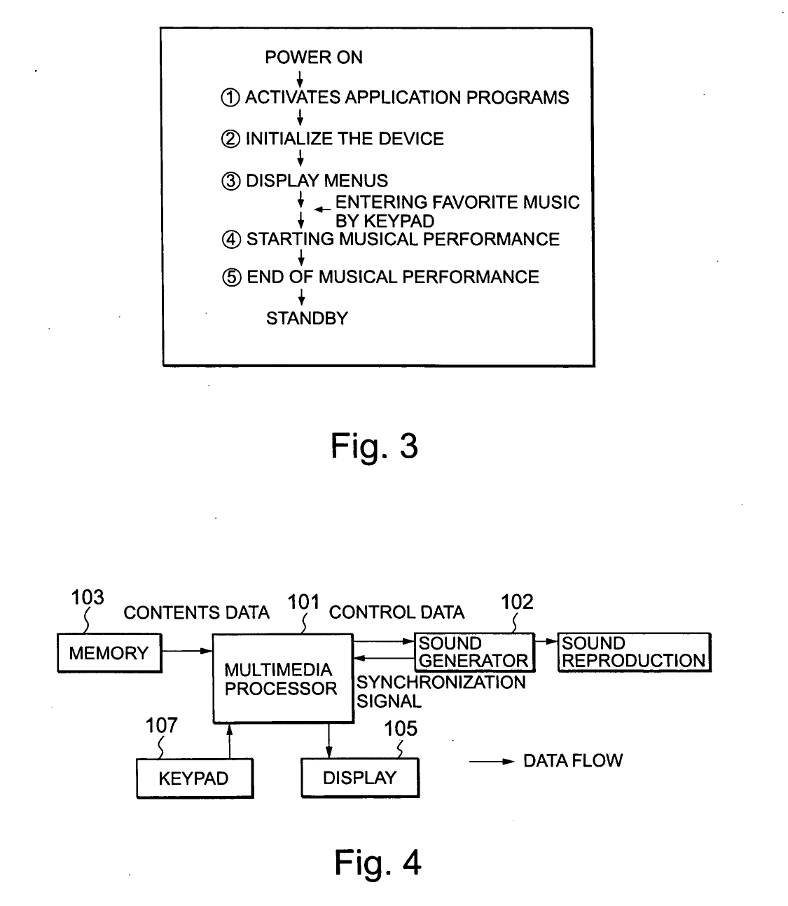

FIG. 3 is a diagram showing an overall flow of operation of this system. When powering on, application programs are activated on multimedia processor 100. Then after initialization the devices such as sound generator 102, LCD display 105, menus are displayed on the LCD display 105. When a user selects a favorite music by operating the external interface such as the keypad, musical performance is started.

FIG. 4 is a diagram showing data flow between devices of this system. When a song data is selected by operating the keypad, application drivers operating on the multimedia processor 101 loads selected content data from the memory 103. The contents data include character data, picture data, audio data that are necessary for karaoke playing and also include data describing karaoke operation procedures (i.e. event data) beside the header data and the song data.

The application driver that is operated on the multimedia processor analyzes the contents data and sends appropriate data to each device. For examples, the driver sends picture data to the LCD display, and audio data to the sound generator 102. Each device operates according to the receiving data. The LCD display, for example, displays characters and images.

The sound generator 102 playbacks music via an sound reproduction interface when receiving audio data, but when receiving the synchronization messages it send back the interrupt signal indicating event occurring timings to the multimedia processor without playing music.

The multimedia processor 101, when receiving the event request interruption, executes the events. The events are grouped and described in time order. A group of events includes more than one simultaneously executable event. The multimedia processor reads a group of events and executes the event immediately at each time when occurring event request interruption.

In this way, the multimedia processor can control event occurring timing and can execute events in time sequence according to the interruption occurred by messages embedded in song data.

As mentioned above, according to the embodiment, multimedia processor has no need to manage time and has no need to control timer for synchronizing between display of character or picture and music, so the load of the system is reduced

Also, as the contents are configured in sequential along the order of the song data, contents generating process corresponds to the order of karaoke events, and the events information is not restricted, so the system is widely expandable. Additionally extraneous multi event processing, such as displaying on LCD display or playing back audio files, can be processed simultaneously.

Next the karaoke song data for realizing above mentioned karaoke system is described in detail.

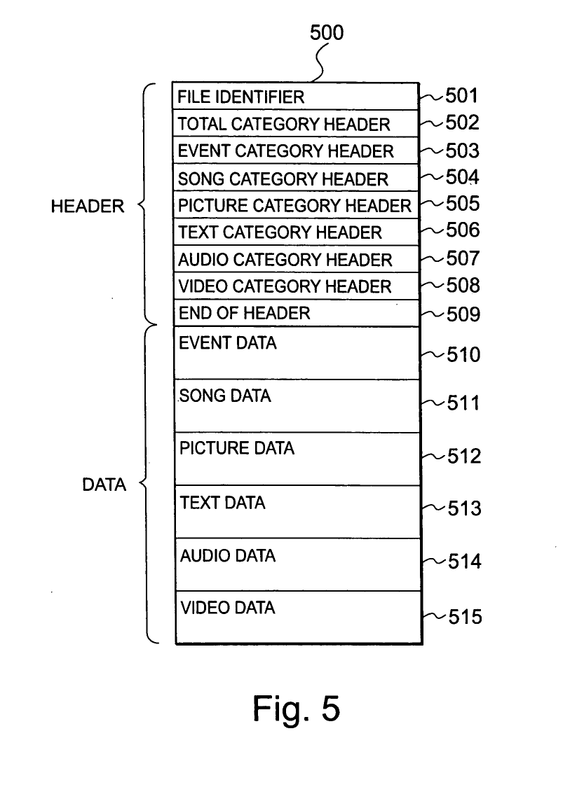

FIG. 5 is a diagram showing a data structure of karaoke song data. The body of karaoke song data 500 includes the Header part and the Data part. The Header part comprises a File Identifier 501 for identifying file type, a Total Category Header 502 for registering artist and so on, a Event Category Header 503 for describing the event data address (offset from the top of the data) and the size on the song data body 500, a Song Category Header 504 for describing the song data address and the size on the song data body 500, a Picture Category Header 505 for describing the picture data address and the size on song data body 500, a Text Category Header 506 for describing the text data address and the size on the song data body 500, an Audio Category Header 507 for describing the data address and the size on the song data body 500, a Video Category Header 508 for describing the data address and the size on the song data body 500, a nd End of Header Information 509 for indicating the end of the header.

The Data part comprise Event Data 510 for describing the karaoke event, Song data 511 for storing song data, Picture Data 512 for storing picture information, Text Data 513 for storing text information, Audio data 514 for storing audio information, and Video Data 515 for storing moving picture information.

FIG. 9 is a diagram showing an exemplary data of Event Data. An Event Data of this embodiment comprise Event ID (“E”) 901 for indicating the bound of the event, a Number of Event 902 included in one bound of event, and Event Data 903-905 according the number of event.

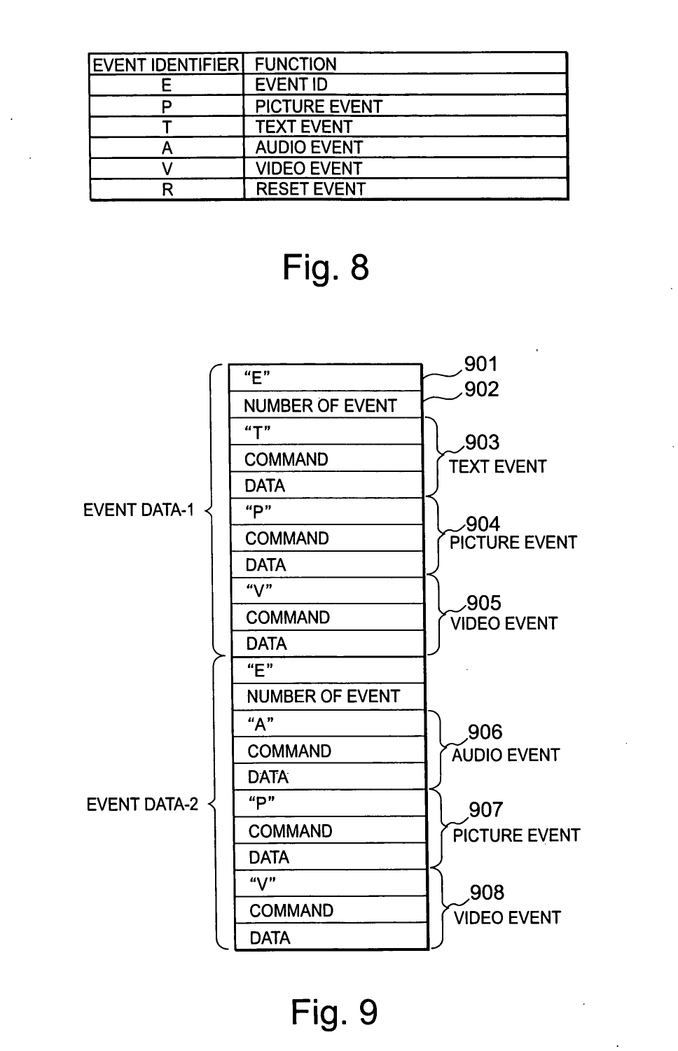

Event Data also includes Picture Event (904,907) for displaying pictures, Text Event 903 for displaying text, Audio Event 906 for playing audio, Video Event (905,908) for displaying moving images, and Reset Event for resetting event execution. These events are identified by the identifiers shown in FIG. 8.

The Song Data shown in FIG. 5 includes data for playing music. In general, SMF data is used for describing song data.

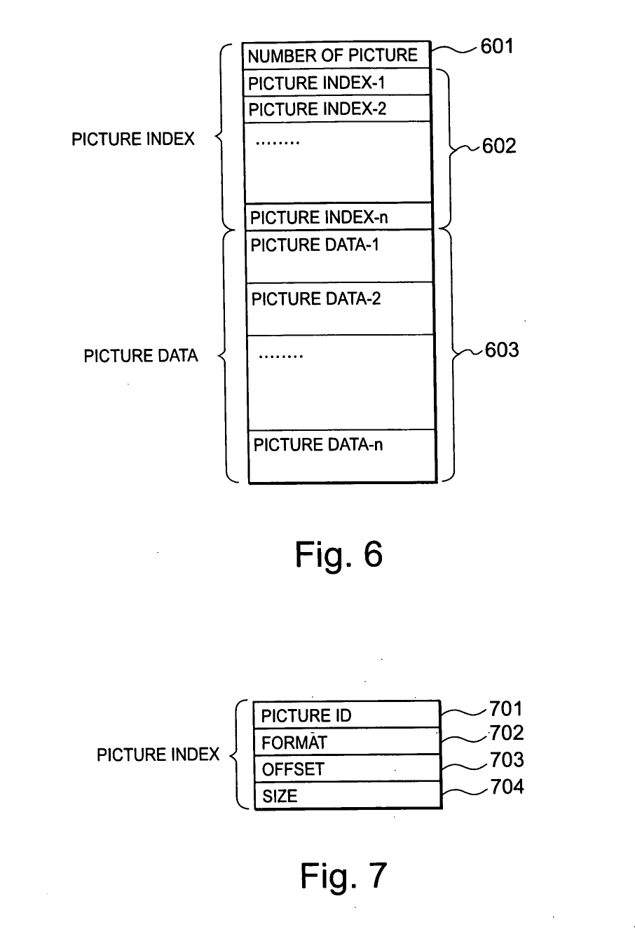

FIG. 6 is a diagram showing an exemplary structure of Picture Data. The Picture Data 512 includes index information and image data 603. The index information is constructed by information 601 for indicating a number of images stored and image indexing information 602 corresponding to the number of images.

FIG. 7 is a diagram showing a content of Picture Index information. The Index information is constructed by Picture Identification (Picture ID) number 701, Picture format 702, Offset value 703 indicating the location of the picture, and the size of picture 704.

The data construction of the Text Data 513, Audio-Data 514, Video Data 515, shown in FIG. 5 is almost same as shown in FIG. 6.

The method for playing karaoke song shown by karaoke song data configuration 500 will be described below.

First, Header information of the karaoke song data 500 is read. The information necessary for playing karaoke is read by each header information 501-509, and the preparation for playing karaoke is done.

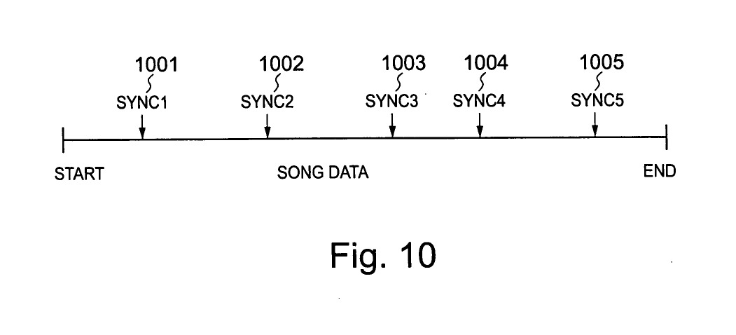

Next, the Song Data 511 is send to the sound generator 102, and karaoke song is played. The synchronization data is embedded in the Song Data for timing event execution as shown in FIG. 10. The synchronization data is special data strings that can be read by sound generator. For example, the data of MIDI channel 10 of note number 127 is assigned as synchronization data.

The sound generator, when receiving the synchronization data, sends this information to the multimedia processor. The multimedia processor searches Event Identifier 901 from the Event Data 901. Then, Number of Event 902 is read and the event number necessary for the event execution is obtained. The Event Data is read after that. As the Event Data 903 shown in FIG. 9 is Text Event, text data is read from the Text Data 513 and the text data is displayed.

After completing the process of the Text Event 903 Picture Event 904 will be done. The picture data indicated by the Picture Data 512 is read and the data is displayed in the process of the Picture Event 904.

In case of Video Event 905, data is read from Video Data 515 and reproduction of video is done similarly.

When the sound generator reads next synchronization data, the second Event Data Identifier is read, and the event process is done similarly.

As mentioned above a number of event executions are done simultaneously at one time reading of Event Identifier.

The event processing is basically done in overlapping mode of overlapping a new event on the previously executed event. Namely, a picture is displayed by Picture Event, then the picture is overlapped by characters by Text Event. So, the picture is stacked on the previous picture in order.

In case of reprocessing a event by clearing previous event process status on the way of playing music, for example displaying picture, clearing of previously displayed picture should be done first by Picture Event, then a new Picture Event should be done for displaying a new picture. In case of a number of event such as displaying picture, moving picture, character, are processed simultaneously, clear event for clearing previous event should be done for each event.

The Reset Event shown in FIG. 8 clears all previous event before Reset Event is executed. By use of Reset Event all event can be cleared easily.

As mentioned above, by grouping a number of events, multiple event processing can be done simultaneously by using synchronizing data embedded in song data. For example, music, lyric and picture can be controlled simultaneously.

Also, a previously executed event can be cleared easily by Reset Event, and bounding of event can be inserted easily in song data. To introduce the concept of event bounding, bounding zone can be replaced easily in song data, and the cleaning process can be done easily.

The present invention is not restricted in above mentioned embodiment, but rather can be transformed in another form as is mentioned below.

(a) the timing description method is not restricted at event execution timing when the event can be recognized by sound generator.

(b) the data configuration is not restricted in above mentioned format, but any data format can be useful if it can be used at the terminal device:

What is claimed is:

1. A karaoke service method by mobile device, said method comprising the steps of:
generating karaoke contents including karaoke event data therein; and
synchronizing said karaoke event data by executing said event included in time order in said music contents according to a timing indicated by synchronization data embedded in song data.

2. A karaoke service system by mobile device, said system comprising:
a memory for storing karaoke contents including karaoke event data therein; and
a synchronizing means for synchronizing said karaoke event by executing said event included in time order in said karaoke contents according to a timing indicated by synchronization data embedded in song data.

3. The system as claimed in claim 2, said synchronizing means comprising:
a sound generator for responding interrupt signal when receiving said synchronization data; and
a multimedia processor for executing events notified by said interrupt signal that give a event occurring timing.

4. The system in claim 2, wherein said events are grouped into some group and are described in time order.

5. The system in claim 2, wherein said events can be divided into a number of event zones by executing a reset event.
